(19) United States
(12) Patent Application Publication
(10) Pub. No.: US 2021/0127054 A1
(43) Pub. Date: Apr. 29, 2021

(54) ELECTRONIC DEVICE AND CONTROL METHOD THEREOF

(71) Applicant: CANON KABUSHIKI KAISHA, Tokyo (JP)

(72) Inventors: Yasunari Fujii, Tokyo (JP); Jun Kamiya, Kanagawa (JP)

(21) Appl. No.: 17/076,402

(22) Filed: Oct. 21, 2020

(30) Foreign Application Priority Data
Oct. 23, 2019 (JP) 2019-192660

(51) Int. Cl. H04N 5/232; G06F 3/0354; G06F 3/0488

(52) U.S. Cl. CPC H04N 5/23216; G06F 3/0488; G06F 3/03547

(57) ABSTRACT

An electronic device according to the present invention, includes: a particular operation member operable in a first direction by moving an operation body in the first direction; a touch operation member provided further toward a side of the first direction than the particular operation member; and at least one memory and at least one processor which function as a control unit configured to perform control to disable a first kind of operation on the touch operation member in response to that a first condition including performing of operation on the particular operation member in the first direction is satisfied.

### BACKGROUND OF THE INVENTION

### Field of the Invention

The present invention relates to an electronic device including an operation member and a touch operation member.

### Description of the Related Art

The prior art includes a technology in which, in a case where touch operation that is performed on a touch operation member is an operation of switching states of an electronic device, with the operation being different from touch operation that instructs execution of a predetermined function, the touch operation member is switched between enabling and disenabling states (Japanese Patent Application Publication No. 2016-162379).

There may be a case where another operation member (referred to as a particular operation member) is provided near the touch operation member. In such a case, an operation body (for example, a finger), which has operated on or is about to operate on the particular operation member, may exert excessive force and unintendedly touch the touch operation member. The touch operation caused in this manner and detected may give rise to erroneous operation rather than touch operation intended by a user. In the prior art, a problem like this is not taken into account.

### SUMMARY OF THE INVENTION

In view of the foregoing, the present invention provides a technique to reduce occurrence of erroneous operation attributable to erroneous touch operation by an operation body which performs operation on a particular operation member.

An electronic device according to the present invention, includes: a particular operation member operable in a first direction by moving an operation body in the first direction; a touch operation member provided further toward a side of the first direction than the particular operation member; and at least one memory and at least one processor which function as a control unit configured to perform control to disable a first kind of operation on the touch operation member in response to that a first condition including performing of operation on the particular operation member in the first direction is satisfied.

Further features of the present invention will become apparent from the following description of exemplary embodiments with reference to the attached drawings.

### BRIEF DESCRIPTION OF THE DRAWINGS

FIGS. 1A and 1B are external views of a digital camera 100;

FIG. 2 is a block diagram of the digital camera 100;

FIG. 3 is a flowchart for illustrating touch bar disabling processing; and

FIG. 4 is a flowchart for illustrating touch operation processing.

### DESCRIPTION OF THE EMBODIMENTS

External Views of Digital Camera 100

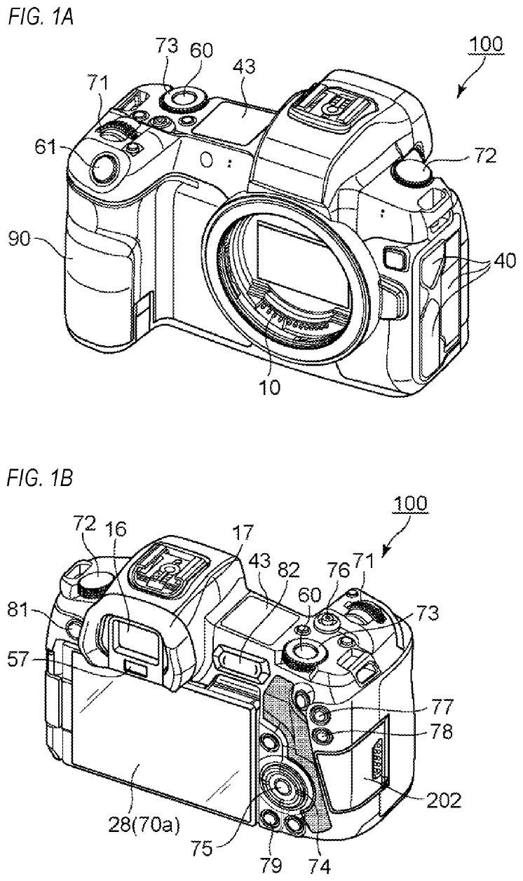

A preferred embodiment of the present invention will be described with the accompanying drawings. FIGS. 1A and 1B are external views of a digital camera 100 as an example of a device (electronic device) to which the present invention can be applied. FIG. 1A is a front perspective view of the digital camera 100, and FIG. 1B is a rear perspective view of the digital camera 100.

A display unit 28 is provided at the rear side of the digital camera 100 and displays images and various kinds of information. A touch panel 70a can detect touch operation on the display surface (touch operation surface) of the display unit 28. An extra-finder display unit 43 is provided on the upper surface of the digital camera 100 and displays various setting values for the digital camera 100 such as a shutter speed and an aperture. A shutter button 61 is an operation member for giving a shooting instruction. A mode selecting switch 60 is an operation member for switching among various modes. A terminal cover 40 protects a connector (not shown) for example with a connection cable which connects the digital camera 100 to an external device.

A main electronic dial 71 is a rotating operation member, and as the main electronic dial 71 is turned, a set value, such as a shutter speed and an aperture can be changed. The power supply switch 72 is an operation member which switches between the on and off states of the power supply for the digital camera 100. A sub-electronic dial 73 is a rotating operation member (rotating dial), and by turning the sub-electronic dial 73, a selection frame (cursor) can be moved or an image can be fed. A four-way key 74 has upper, lower, left, and right portions which can be pressed, and processing according to a pressed portion of the four-way key 74 can be performed. A SET button 75 is a push button and mainly used to determine a selection item.

A moving image button 76 is used to start or stop shooting (recording) a moving image. An AE lock button 77 is a push button, and an exposure condition can be fixed by pressing the AE lock button 77 in a shooting standby mode. An enlargement button 78 is an operation button for switching between the on and off states of an enlargement mode in a live view display (LV display) in the shooting mode. When the enlargement mode is set to an on state and then the main electronic dial 71 is operated, a live view image (LV image) can be enlarged or reduced. In a playback mode, the enlargement button 78 serves as an operation button to enlarge a playback image or increase the magnification thereof. A playback button 79 is an operation button for switching between the shooting mode and the playback mode. When the playback button 79 is pressed in the shooting mode, the playback mode is changed to the playback mode, and the latest image among the images recorded in a recording medium 200 (which will be described) can be displayed on the display unit 28. A menu button 81 is a push button used to execute instruction operation for displaying a menu screen, and when the menu button 81 is pressed, a menu screen which allows various settings to be made is displayed on the display unit 28. The user can perform various settings intuitively using the menu screen displayed on the display unit 28 and the four-way key 74 or the SET button 75.

A touch bar 82 (multi-function bar: M-Fn bar) is a line-shaped touch operation member (line touch sensor) capable of accepting touch operation. The touch bar 82 is positioned in a touch-operable (touchable) position with the thumb of the right hand holding a grip portion 90 in a normal gripping manner (as recommended by the manufacturer). The touch bar 82 is a receiving unit capable of receiving touch operation on the touch bar 82 (operation to touch and then release within a predetermined period of time without moving), sliding operation to the right and left (operation to touch and then move the touch position while keeping touching). The touch bar 82 is a different operation member from the touch panel 70a and does not have a display function.

A communication terminal 10 is used to communicate between the digital camera 100 and a lens unit 150 (as a detachable unit which will be described). An eyepiece 16 is the eyepiece of an eyepiece finder 17 (looking-through finder), and the user can visually recognize an image displayed on an EVF 29 therein (which will be described) through the eyepiece 16. An eye-proximity detecting unit 57 is a sensor which detects whether the eye of a user (photographer) is in close proximity to the eyepiece 16. A lid 202 is a lid for a slot for storing the recording medium 200 (which will be described). The grip portion 90 is a holder which allows the digital camera 100 to be held in one hand (the right hand) and has a shape which is easy for the user to grasp with the right hand when moving the digital camera 100. The shutter button 61 and the main electronic dial 71 are arranged in positions operable by the index finger of the right hand while the grip portion 90 is held by the small finger, the ring finger, and the middle finger of the right hand to hold the digital camera 100. The sub-electronic dial 73 and the touch bar 82 are also provided in positions operable by the thumb of the right hand in the same state as the above. In this manner, various operation members can be operated with the same finger of the hand holding the grip portion 90.

Block Diagram of Configuration of Digital Camera 100

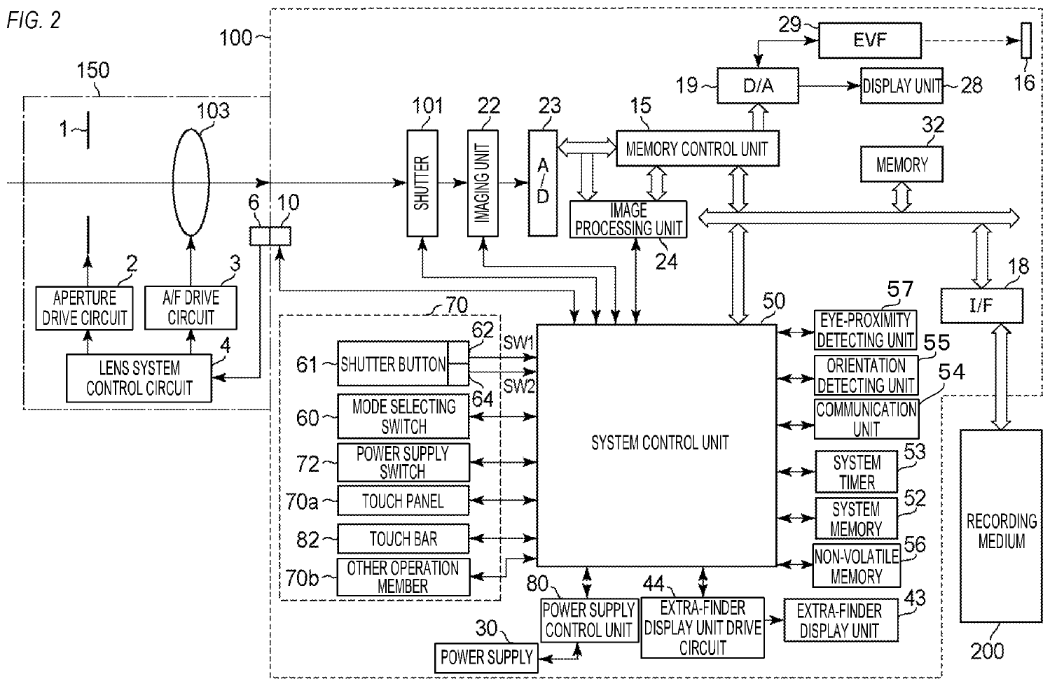

FIG. 2 is a block diagram of an exemplary configuration of the digital camera 100. The lens unit 150 is provided with an exchangeable photographic lens. A lens 103 typically includes a plurality of lenses but FIG. 2 shows only one lens for simplicity. A communication terminal 6 allows the lens unit 150 to communicate with the side of the digital camera 100, and a communication terminal 10 allows the digital camera 100 to communicate with the side of the lens unit 150. The lens unit 150 communicates with a system control unit 50 through the communication terminals 6 and 10. The lens unit 150 controls an aperture 1 through an aperture drive circuit 2 by a lens system control circuit 4 provided therein. The lens unit 150 also focuses by displacing the position of the lens 103 through an AF drive circuit 3 by the lens system control circuit 4.

A shutter 101 is a focal plane shutter which can freely control exposure time by an imaging unit 22 under the control of the system control unit 50.

The imaging unit 22 is an imaging device (image sensor) including a CCD or a CMOS device which converts an optical image into an electrical signal. The imaging unit 22 may include an imaging plane phase difference sensor which outputs defocus amount information to the system control unit 50. An A/D converter 23 converts an analog signal output from the imaging unit 22 into a digital signal.

The image processing unit 24 performs predetermined processing (for example, resizing processing such as pixel interpolation and reduction and color conversion processing) to data from the A/D converter 23 or data from a memory control unit 15. The image processing unit 24 performs predetermined arithmetic processing using captured image data, and the system control unit 50 performs exposure control or ranging control on the basis of calculation results obtained by the image processing unit 24. In this way, for example through the lens (TTL) autofocus (AF) processing, automatic exposure (AE) processing, or electronic flash pre-emission (EF) processing is performed. The image processing unit 24 further performs predetermined arithmetic processing using the imaged image data and performs auto-white balance (AWB) processing according to the TTL approach on the basis of the obtained calculation result.

The output data from the A/D converter 23 is written to a memory 32 through the image processing unit 24 and the memory control unit 15. Alternatively, the output data from the A/D converter 23 is written to the memory 32 through the memory control unit 15 and not through the image processing unit 24. The memory 32 stores image data obtained by the imaging unit 22 and converted to digital data by the A/D converter 23 and image data to be displayed on the display unit 28 or the EVF 29. The memory 32 has a sufficient storage capacity for storing a predetermined number of still images and moving images and sounds for a predetermined period of time.

The memory 32 also serves as a memory (video memory) for image display. A D/A converter 19 converts the data for image display stored in the memory 32 into an analog signal and supplies the signal to the display unit 28 or the EVF 29. In this way, the display image data written to the memory 32 is displayed on the display unit 28 or the EVF 29 through the D/A converter 19. The display unit 28 and the EVF 29 each display the analog signal from the D/A converter 19 on a display such as an LCD or an organic EL. A live view display (LV) can be performed as the D/A converter 19 converts, into an analog signal, a digital signal which has been A/D-converted by the A/D converter 23 and stored in the memory 32 and sequentially transfers the signal to the display unit 28 or the EVF 29 for display. Hereinafter, the image displayed in a live view display will be referred to as a live view image (LV image).

Various setting values for the camera such as a shutter speed and an aperture are displayed at the extra-finder display unit 43 through the extra-finder display unit drive circuit 44.

A non-volatile memory 56 is an electrically erasable and recordable memory such as an EEPROM. In the non-volatile memory 56, for example, constants and programs for the operation of the system control unit 50 are recorded. Here, the programs refer to programs for executing various flow charts which will be described in the following description of the embodiment.

The system control unit 50 includes at least one processor or circuit to control the entire digital camera 100. The system control unit 50 executes programs recorded in the non-volatile memory 56 to realize various kinds of processing according to the embodiment, which will be described below. The system memory 52 is for example a RAM, and the system control unit 50 deploys, in the system memory 52, a constant, a variable, and a program read out from the non-volatile memory 56 for the operation of the system control unit 50. The system control unit 50 also controls for example the memory 32, the D/A converter 19, and the display unit 28 to perform display control.

A system timer 53 is a clock unit which measures time used for various kinds of control and the time of a built-in clock.

A power supply control unit 80 includes for example a battery detecting circuit, a DC-DC converter, and a switch circuit which switches an energizing block and detects insertion of a battery, the type of the battery if any, and the remaining amount of the battery. The power supply control unit 80 also controls the DC-DC converter on the basis of the detection results and instructions from the system control unit 50 and provides necessary voltage for a necessary period of time to each of the components which include the recording medium 200. A power supply 30 includes a primary battery such as an alkaline battery and a lithium battery, a secondary battery such as a NiCd battery, a NiMH battery, and a Li battery, and an AC adapter.

The recording medium I/F 18 is an interface with the recording medium 200 such as a memory card and a hard disk. The recording medium 200 is a recording medium such as a memory card for recording a captured image and includes a semiconductor memory and a magnetic disk.

A communication unit 54 transmits/receives video and audio signals to/from an external device connected wirelessly or by a wire cable. The communication unit 54 can also be connected to a wireless local area network (LAN) or the Internet. The communication unit 54 can also communicate with external devices using Bluetooth (registered trademark) or Bluetooth Low Energy. The communication unit 54 can transmit an image captured by the imaging unit 22 (including an LV image) or an image recorded in the recording medium 200 and can receive image data or other kinds of information from an external device.

An orientation detecting unit 55 detects the orientation of the digital camera 100 with respect to the gravitational direction. It can be determined on the basis of the orientation detected by the orientation detecting unit 55 whether an image captured by the imaging unit 22 is an image captured with the digital camera 100 having its lengthwise direction aligned with the horizontal or vertical direction. The system control unit 50 can add orientation information corresponding to the orientation detected by the orientation detecting unit 55 to the image file of the image captured by the imaging unit 22 or rotate the image to record the image. As the orientation detecting unit 55, an acceleration sensor or a gyro sensor can be used. The movement of the digital camera 100 (for example whether the camera is panned, tilted, lifted, or stationary) using an acceleration sensor or a gyro sensor as the orientation detecting unit 55.

The eye-proximity detecting unit 57 is an eye-proximity sensor which detects approaching and separation of the eye (object) to and from the eyepiece 16 (proximity detection) of an eyepiece finder 17 (hereinafter simply referred to as a “finder”). The system control unit 50 switches between display (a display state) and non-display (a non-display state) at the display unit 28 and the EVF 29 depending on the state detected by the eye-proximity detecting unit 57. More specifically, when where to display is automatically switched at least in the shooting stand-by state, the display unit 28 is turned on as where to display and the EVF 29 is turned off while the eye is separated. The EVF 29 is turned on as where to display while the eye is in close proximity, and the display unit 28 is turned off. An infrared proximity sensor may be used as the eye-proximity detecting unit 57 to detect approaching of any object to the eyepiece 16 of the finder 17 which includes the EVF 29. When an object approaches, infrared light emitted from the light emitting unit (not shown) of the eye-proximity detecting unit 57 is reflected by the object and the reflected light is received by the light receiving unit (not shown) of the infrared proximity sensor. It can be determined, on the basis of the amount of received infrared light, how close the object is to the eyepiece 16 (eye-approaching distance). As described above, the eye-proximity detecting unit 57 performs eye-proximity detection for detecting the proximity of the object to the eyepiece 16. When an object approaching the eyepiece 16 within a predetermined distance is detected from an eye-separated state (non-proximity state), it is determined that the eye is in close proximity to the eyepiece. When the object detected as approaching has moved at least a predetermined distance apart from the eye-approaching state (proximity state), it is determined that the object has been separated from the eyepiece. A threshold for detecting eye approaching and a threshold for detecting eye separating may be set to different values, for example, by setting hysteresis. After eye approaching is detected, the eye-approaching state continues until eye separation is detected. After separation of the eye is detected, the eye-separated state continues until eye approaching is detected. Note that the infrared proximity sensor is only an example and the eye-proximity detecting unit 57 may be any other sensor capable of detecting approaching of the eye or an object which can be regarded as approaching of the eye.

The operation unit 70 is an input unit which receives operation by a user (user operation) and is used to input various operation instructions to the system control unit 50. As shown in FIG. 2, the operation unit 70 includes the mode selecting switch 60, the shutter button 61, the power supply switch 72, the touch panel 70a, and the touch bar 82. The operation unit 70 also includes the main electronic dial 71, the sub-electronic dial 73, the four-way key 74, the SET button 75, a moving image button 76, the AE lock button 77, the enlargement button 78, the playback button 79, and the menu button 81 as other operation member 70b.

The mode selecting switch 60 switches the operation mode of the system control unit 50 to one of a still image shooting mode, a moving image shooting mode, and the playback mode. The still image shooting mode include an auto shooting mode, an auto scene determining mode, a manual mode, an aperture priority mode (Av mode), a shutter speed priority mode (Tv mode), and a program AE mode (P mode). There are various scene modes for shooting settings depending on each shooting scene and custom modes. The mode selecting switch 60 allows the user to switch the mode directly to one of these modes. Alternatively, after switching to a screen indicating a shooting mode list by the mode selecting switch 60, other operation members may be used to selectively switch the mode to any of the multiple modes displayed. Similarly, a plurality of modes may be included in the moving image recording mode.

The shutter button 61 includes a first shutter switch 62 and a second shutter switch 64. During the operation of the shutter button 61, the first shutter switch 62 is turned on by so-called half push (shooting preparation instruction) and generates a first shutter switch signal SW1. The system control unit 50 starts shooting preparation operation such as autofocus (AF) processing, auto exposure (AE) processing, auto-white balance (AWB) processing, and electronic flash pre-emission (EF) processing in response to the first shutter switch signal SW1. The second shutter switch 64 is turned on by so-called full push (shooting instruction) when the operation of the shutter button 61 is completed and generates a second shutter switch signal SW2. The system control unit 50 starts a series of shooting processing operations from reading of the signal from the imaging unit 22 to writing of a captured image as an image file to the recording medium 200 in response to the second shutter switch signal SW2.

The touch panel 70a and the display unit 28 may be integrally configured. For example, the touch panel 70a may be configured such that the transmittance of light does not interfere with display on the display unit 28 and may be attached on the upper layer of the display unit 28. Input coordinates on the touch panel 70a are associated with display coordinates on the display surface of the display unit 28. In this way, such a graphical user interface (GUI) is provided that the user feels as if the user can directly manipulate the screen displayed on the display unit 28. The system control unit 50 can detect the following steps of operation or states on the touch panel 70a.
A new touch on the touch panel 70a by a finger or pen which has not touched the touch panel 70a or the start of a touch (hereinafter referred to as a “Touch-Down”).
A state in which the finger or pen is touching the touch panel 70a (hereinafter referred to as a “Touch-On”).
Movement of the finger or pen while still touching the touch panel 70a (hereinafter referred to as a “Touch-Move”).
Movement (release) of the finger or pen which was touching the touch panel 70a away from the touch panel 70a or the end of the touch (hereinafter referred to as a “Touch-Up”).
Nothing touches the touch panel 70a (hereinafter referred to as a “Touch-Off”).

When a Touch-Down is detected, a Touch-On is detected at the same time. After a Touch-Down is detected, a Touch-On normally continues to be detected until a Touch-Up is detected. When a Touch-Move is detected, a Touch-On is detected at the same time. Even when a Touch-On is detected, and the touch position is not moved, a Touch-Move is not detected. After a Touch-Up is detected for all of fingers or pen in touch with the touch panel, a Touch-Off is detected.

These steps of operation and states and the coordinates of the position in which the finger or pen touches on the touch panel 70a are notified to the system control unit 50 through an internal bus. The system control unit 50 determines what kind of operation (touch operation) has been performed on the touch panel 70a on the basis of the notified information. As for a Touch-Move, the moving direction of the finger or pen moving on the touch panel 70a can be determined for each of the vertical and horizontal components on the touch panel 70a on the basis of changes in the position coordinates. When a Touch-Move over at least a predetermined distance is detected, it is determined that sliding operation has been performed. Operation to quickly move the finger in contact with the touch panel 70a over a certain distance and then release the finger is referred to as a flick. Stated differently, a flick is operation to quickly trace on the touch panel 70a as if lightly striking the panel with the finger. When a Touch-Move at a predetermined speed or higher over at least predetermined distance is detected, followed directly by detection of a Touch-Up, it can be determined that a flick has been performed (sliding operation followed by a flick is determined). Touch operation to simultaneously touch multiple positions (such as two positions) and bring these touching positions close to each other is referred to as a “pinch-in”. Touch operation to move these touching positions apart from each other is referred to as a “pinch-out”. A pinch-out and a pinch-in are collectively referred to as pinch operation (or simply referred to as a “pinch”). The touch panel 70a may be any of various types of panels which include a resistance film type, a capacitance type, a surface acoustic wave type, an infrared type, an electromagnetic induction type, an image recognition type, and an optical sensor type. A touch is detected when the finger or pen comes into contact with the touch panel or when the finger or pen comes close to the touch panel depending on the type, and either of the types can be used.

The system control unit 50 can detect the following steps of operation or states on the touch bar 82.
A new touch on the touch bar 82 by a finger or pen which has not touched the touch bar 82 or the start of a touch (hereinafter referred to as a “Touch-Down”).
A state in which the finger or pen is touching the touch bar 82 (hereinafter referred to as a “Touch-On”).
Movement of the finger or pen while still touching the touch bar 82 (hereinafter referred to as a “Touch-Move”).
Movement (release) of the finger or pen which was touching the touch bar 82 away from the touch bar 82 or the end of the touch (hereinafter referred to as a “Touch-Up”).
Nothing touches the touch bar 82 (hereinafter referred to as a “Touch-Off”).

When a Touch-Down is detected, a Touch-On is detected at the same time. After a Touch-Down is detected, a Touch-On normally continues to be detected until a Touch-Up is detected. When a Touch-Move is detected, a Touch-On is detected at the same time. Even when a Touch-On is detected, and the touch position is not moved, a Touch-Move is not detected. After a Touch-Up is detected for all of fingers or pen in touch with the touch panel, a Touch-Off is detected.

These steps of operation and states and the coordinates of the position in which the finger or pen touches on the touch bar 82 are notified to the system control unit 50 through an internal bus and the system control unit 50 determines what kind of operation (touch operation) has been performed on the touch bar 82 on the basis of the notified information. As for a Touch-Move, movement on the touch bar 82 in the horizontal direction (left-right direction) is detected. When it is determined that the touch position has moved over at least a predetermined distance (movement for at least a predetermined amount), it is determined that sliding operation has been performed. When there is operation to touch on the touch bar 82 with the finger and release the finger within a predetermined time period, it is determined that tap operation has been performed without sliding. According to the embodiment, the touch bar 82 is a capacitive touch sensor. Meanwhile, the sensor may be any of various types of touch sensors which include a resistance film type, a surface acoustic wave type, an infrared type, an electromagnetic induction type, an image recognition type, and an optical sensor type.

Arrangement of Sub-Electronic Dial 73 and Touch Bar 82

When the digital camera 100 is viewed from its rear side, as shown in FIG. 1B, the touch bar 82 is provided on the left side (first direction side) of the sub-electronic dial 73. A plurality of operation members are provided on the left side of the sub-electronic dial 73 and on the rear side of the digital camera 100. Since the sub-electronic dial 73 is operated (turned) from the rear side of the digital camera 100, the rear side of the digital camera 100 can be considered as an operation surface side for the sub-electronic dial 73. The touch bar 82 is an operation member positioned closest to the sub-electronic dial 73 among the plurality of operation members. Therefore, the touch bar 82 is positioned on the left of the sub-electronic dial 73 without any other operation member interposed therebetween.

The sub-electronic dial 73 is rotatable to the left (first direction) or the right (second direction), and the user moves the operation body (the thumb of the right hand holding the grip portion 90 according to the embodiment) to the left or right to rotate the sub-electronic dial 73 to the left or right. When the sub-electronic dial 73 and the touch bar 82 are arranged in the above described manner, the operation body which has operated upon or is about to operate upon the sub-electronic dial 73 could move with excessive force and unintendedly touch the touch bar 82. The touch operation caused in this manner may give rise to erroneous operation rather than the touch operation intended by the user. In particular, when the touch bar 82 is provided within a distance of 2 cm to the left from the sub-electronic dial 73, the operation body is more likely to inadvertently touch the touch bar 82.

Note that the particular operation member which could cause the operation body to unintentionally touch the touch bar 82 is not limited to the sub-electronic dial 73. When other operation members which can be operated to the left or right are arranged in the same manner as the sub-electronic dial 73, operation of any of those operation members may cause the operation body to unintentionally touch the touch bar 82. For example, operation (sliding) of a slidable switch to the left or right may cause the operation body to unintentionally touch the touch bar 82.

In view of the above-described problem (possible erroneous operation caused by detected touch operation which is not user intended touch operation), the following touch bar disabling processing is performed according to this embodiment.

Touch Bar Disabling Processing

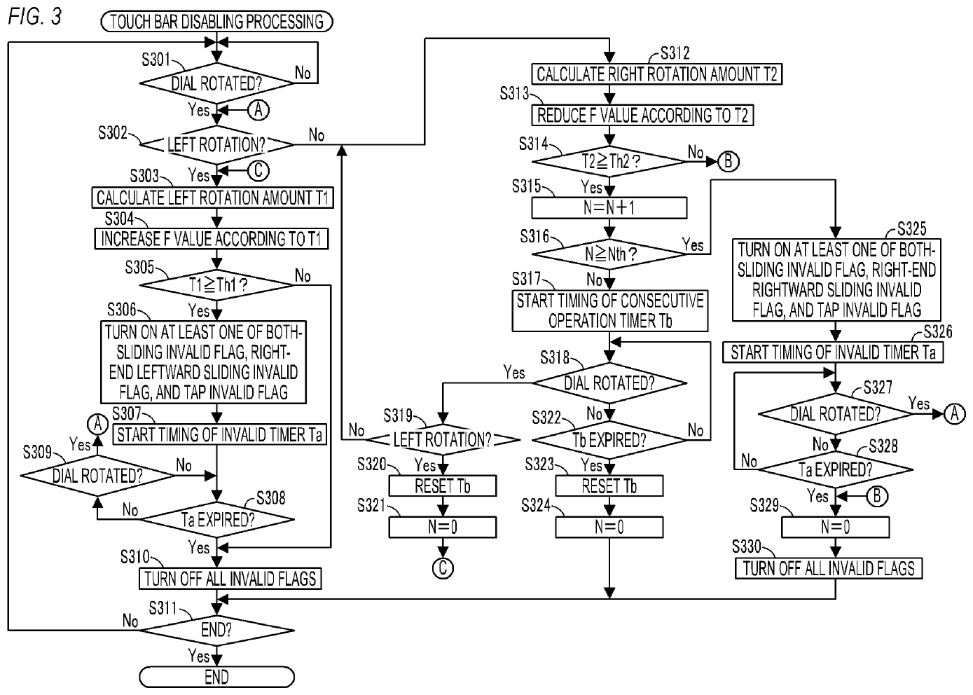

FIG. 3 is a flowchart for illustrating details of the touch bar disabling processing performed in the digital camera 100. The processing is implemented as the system control unit 50 deploys a program recorded in the non-volatile memory 56 in the system memory 52 and executes the program. For example, when the digital camera 100 is activated while the touch bar disabling processing is set to be carried out, the processing in FIG. 3 starts.

In S301, the system control unit 50 determines whether the sub-electronic dial 73 has been rotated. The process stands by for turning and then proceeds to S302 when rotation occurs.

In S302, the system control unit 50 determines whether the detected rotation is left rotation (counterclockwise rotation). The process proceeds to S303 for left rotation, otherwise the process proceeds to S312 (for right rotation (clockwise rotation)).

In S303, the system control unit 50 calculates the left rotation amount (operation amount) T1 for example as the rotation number (per unit time) or the rotation angle in the detected left rotation on the basis of an output signal from the sub-electronic dial 73.

In S304, the system control unit 50 increases the F value by an increase amount corresponding to the left rotation amount T1 calculated in S303. In the following description of the embodiment, a function for changing the F value is allocated to the rotation of the sub-electronic dial 73 as an example, but the function allocated to the rotation of the sub-electronic dial 73 is not particularly limited. For example, the function may be image feeding (processing to switch between image files of still images or moving images to be reproduced and displayed), changing the frame to be displayed in one motion image, changing the volume of sound, or changing music to be played. Alternatively, the function may be changing shooting parameters such as an ISO sensitivity and a shutter speed or image processing parameters such as a brightness adjustment value and a color adjustment value. The function of changing various parameters such as a date or hour/minute/second for date setting, a selection target in an address book, and a page to be displayed in a document may be allocated to the sub-electronic dial 73.

In S305, the system control unit 50 determines whether the left rotation amount T1 calculated in S303 is at least a predetermined amount Th1. When the left rotation amount T1 is at least the predetermined amount Th1, the process proceeds to S306, otherwise the process proceeds to S309. Although not particularly limited, the predetermined amount Th1 corresponds to the amount of one rotation by the sub-electronic dial 73 according to the embodiment. The touch operation to the touch bar 82 is disabled in S306, which will be described below. When the sub-electronic dial 73 is greatly rotated, the finger may touch the touch bar 82 with excessive force, and unintended touch operation may be detected. Therefore, according to the embodiment, when the operation for rotating the sub-electronic dial 73 is performed for at least a predetermined amount, the process proceeds to S306. Note that except for the condition of the left rotation amount T1, when operation is performed to rotate the sub-electronic dial 73 to the left (Yes in S302, for example next to S304), the process may proceed to S306.

In S306, the system control unit 50 turns on a flag (invalid flag) which disables a first kind of operation on the touch bar 82. The first kind of operation can be unintentionally performed by a finger (operation body) which turns the sub-electronic dial 73 to the left and is disabled for a predetermined period using the invalid flag and an invalid timer Ta according to the embodiment. Since the finger is moved to the left when the sub-electronic dial 73 is rotated to left, sliding operation (leftward sliding) which moves the touch position to the left may be performed unintentionally. In particular, since the right end of the touch bar 82 (the portion of the operation surface of the touch bar 82 within a predetermined range from the right end) is closer to the sub-electronic dial 73 than the other portion of the touch bar 82, leftward sliding (the leftward sliding from the right end) is easily unintentionally performed starting from the right end. Therefore, in S306, one of the following flags may be turned on. The flag to be turned on may or may not be set by the user.
Both slide disabling flag: a flag to disable both leftward sliding and rightward sliding (sliding operation to move the touch position to the right) regardless of their starting positions.
Right-end leftward sliding disable flag: a flag to disable leftward sliding started at the right end of the touch bar 82.

A finger which rotates the sub-electronic dial 73 to the left touches the left end of the touch bar 82 (a portion of the operation surface of the touch bar 82 within a predetermined range from the left end) without touching the right end and the middle portion of the touch bar 82, and tap operation (leftward tap) at the left end may be performed unintentionally. Therefore, in S306, a tap invalid flag to disable the tap operation can be turned on regardless of the position where the tap has been performed. A leftward tap invalid flag to disable a leftward tap may be turned on.

Therefore, erroneous operation caused by incorrect touch operation with the finger which operates on the sub-electronic dial 73 can be reduced. Kinds of operation other than the operation disabled by the on flag are not disabled, so that the decrease in the operability of the touch bar 82 can be reduced. For example, tapping (rightward tap) at the right end of the touch bar 82 is not disabled, and sliding operation started outside the right end (outside the predetermined range) is not disabled unless the both-sliding invalid flag is turned on.

The following flags may be used to disable leftward sliding.
Leftward sliding invalid flag: a flag to disable leftward sliding regardless of whether the leftward sliding is started at the right end of the touch bar 82.
Right-end both-sliding invalid flag: a flag to disable leftward sliding started at the right end of the touch bar 82 and rightward sliding started at the right end of the touch bar 82.

In S307, the system control unit 50 resets the invalid timer Ta for keeping the invalid flag (the state in which touch operation on the touch bar 82 is disabled) on for the touch bar 82, and then starts the invalid timer Ta. Although not particularly limited, the invalid timer Ta is set to 150 msec (0.15 seconds) according to the embodiment.

In S308, the system control unit 50 determines whether the invalid timer Ta has expired. When the invalid timer Ta expires (when the period Ta elapses from turning on of the invalid flag for the touch bar 82 (disabling of the touch operation on the touch bar 82)), the process proceeds to S310, otherwise the process proceeds to S309.

In S309, the system control unit 50 determines whether the sub-electronic dial 73 has been rotated. When rotation occurs, the process proceeds to S302, otherwise the process proceeds to S308.

In S310, the system control unit 50 turns off all of invalid flags for the touch bar 82.

In S311, the system control unit 50 determines whether to end the touch bar disabling processing. If the touch bar disabling processing is not completed, the process proceeds to S301. Otherwise, the process ends the touch bar disabling processing. For example, when the user instructs to cancel the setting for the touch bar disabling processing or turn off the power supply for the digital camera 100, the system control unit 50 ends the touch bar disabling processing.

In S312, when the right rotation is determined in S302, the system control unit 50 calculates a right rotation amount (operation amount) T2 such as the rotation number (per unit time) or the rotation angle in the detected right rotation on the basis of an output signal from the sub-electronic dial 73.

In S313, the system control unit 50 reduces the F value by a reduction amount corresponding to the right rotation amount T2 calculated in S312.

In S314, the system control unit 50 determines whether the right rotation amount T2 calculated in S313 is at least a predetermined amount Th2. If the right rotation amount T2 is at least the predetermined amount Th2, the process proceeds to S315, otherwise the process proceeds to S329. Although not particularly limited, the predetermined amount Th2 corresponds to the amount of two rotations of the sub-electronic dial 73 according to the embodiment. Since the operation of turning the sub-electronic dial 73 largely to the right is often started by placing the pad of the finger (operation body) on the sub-electronic dial 73, the fingertip (the tip of the finger (operation body)) easily touches the touch bar 82 unintendedly during the operation. Meanwhile, since the operation of rotating the sub-electronic dial 73 slightly to the right is often started by placing the tip of the finger on the sub-electronic dial 73, the finger (operation body) is not likely to touch the touch bar 82 during the operation. Therefore, according to the embodiment, the predetermined amount Th2 is larger than the predetermined amount Th1.

In S315, the system control unit 50 increments, by one, a variable N representing the number of consecutive steps of operation to rotate the sub-electronic dial 73 to the right by at least the predetermined amount Th2. The variable N (initial value) at the start of the touch bar disabling processing is 0.

In S316, the system control unit 50 determines whether the variable (the number of consecutive steps) N is at least a threshold value Nth. If the variable N is at least the threshold value Nth, the process proceeds to S325, otherwise the process proceeds to S317. Although not particularly limited, the threshold value Nth is set to 2 according to the embodiment. Therefore, when the operation of rotating the sub-electronic dial 73 to the right with the operation amount of at least the predetermined amount Th2 is performed twice in succession, the process proceeds to S325. Touch operation on the touch bar 82 is disabled in S325, which will be described below. When the sub-electronic dial 73 is rotated greatly to the right in a consecutive manner, the reciprocating movement of the finger (operation body) may cause the finger to touch the touch bar 82 with excessive force, and unintended touch operation may be detected. Therefore, according to the embodiment, when the operation of rotating the sub-electronic dial 73 to the right with the operation amount of at least the predetermined amount Th2 is performed in a consecutive manner at least a predetermined number of times, the operation proceeds to S325. Note that except for at least one of the conditions about the variable (number of consecutive steps) N and the right rotation amount T2, the process may proceed to S325 in response to the operation of rotating the sub-electronic dial 73 to the right.

In S317, the system control unit 50 resets a consecutive operation timer Tb as time for determining whether the operation of rotating the sub-electronic dial 73 to the right with an operation amount of at least the predetermined amount Th2 has been consecutively performed, and then starts timing of a consecutive operation timer Tb. Although not particularly limited, the consecutive operation timer Tb is set to 200 msec (0.2 seconds) according to the embodiment. After the operation of rotating the sub-electronic dial 73 to the right with an operation amount of at least the predetermined amount Th2, if the same operation has been performed before the expiration of the consecutive operation timer Tb, it is determined that these steps of operation have been performed consecutively. After the operation of rotating the sub-electronic dial 73 to the right with an operation amount of at least the predetermined amount Th2, if the same operation has been performed after the expiration of the consecutive operation timer Tb, it is not determined that these steps of operation have been performed consecutively.

In S318, the system control unit 50 determines whether the sub-electronic dial 73 has been rotated. If the rotation has occurred, the process proceeds to S319, otherwise the process proceeds to S322.

In S319, the system control unit 50 determines whether the detected rotation is right rotation. The process proceeds to S312 for right rotation, otherwise (for left rotation), the process proceeds to S320.

In S320, the system control unit 50 stops timing of the consecutive operation timer Tb and resets the consecutive operation timer Tb. In S321, the system control unit 50 resets the variable (number of consecutive steps) N to 0.

In S322, the system control unit 50 determines whether the consecutive operation timer Tb has expired. When the consecutive operation timer Tb expires (when the period Tb has elapsed from the operation of rotating the sub-electronic dial 73 to right with an operation amount of at least the predetermined amount Th2), the process proceeds to S323, otherwise the process proceeds to S318.

In S323, the system control unit 50 stops timing of the consecutive operation timer Tb and resets the consecutive operation timer Tb. In S324, the system control unit 50 resets the variable (number of consecutive steps) N to 0.

When it is determined that the variable (number of consecutive steps) N is at least the threshold value Nth in S316, the system control unit 50 turns on a flag (invalid flag) in S325 which disables the second kind of operation on the touch bar 82. The second kind of operation can be unintentionally performed by a finger (operation body) which rotates the sub-electronic dial 73 to right and is disabled for a predetermined period using an invalid flag and an invalid timer Ta according to the embodiment. The rightward sliding may be unintentionally performed because the finger moves to the right when the sub-electronic dial 73 is rotated to right. In particular, since the right end of the touch bar 82 is closer to the sub-electronic dial 73 than the other portion of the touch bar 82, rightward sliding (rightward sliding from the right end; rightward sliding within the right end) started at the right end is more likely to be performed unintentionally. Therefore, in S325, one of the following flags can be turned on. In S325, a tap invalid flag can also be turned on. The flag to be turned on may or may not be set (changed) by the user.
Both-sliding invalid flag: a flag to disable the leftward and rightward sliding regardless of their starting positions.
Right-end rightward sliding invalid flag: a flag to disable rightward sliding started at the right end of the touch bar 82.

In this way, erroneous operation caused by incorrect touch operation with the finger which operates on the sub-electronic dial 73 can be reduced. Kinds of operation except for the operation disabled by the on flag are not disabled, so that the decrease in the operability of the touch bar 82 can be reduced.

The following flags may be used to disable rightward sliding.
Rightward sliding invalid flag: a flag to disable rightward sliding regardless of whether the rightward sliding has been started at the right end of the touch bar 82.
Right-end both-sliding invalid flag: a flag to disable leftward sliding started at the right end of the touch bar 82 and rightward sliding started at the right end of touch bar 82.

In S326, the system control unit 50 resets an invalid timer Ta as time for keeping the invalid flag for the touch bar 82 (in a state in which the touch operation on the touch bar 82 is disabled) and then starts timing of the invalid timer Ta. As described above, the invalid timer Ta is set to 150 msec (0.15 seconds) according to the embodiment though not particularly limited.

In S327, the system control unit 50 determines whether the sub-electronic dial 73 has been rotated. If rotation has occurred, the process proceeds to S302, otherwise the process proceeds to S328.

In S328, the system control unit 50 determines whether the invalid timer Ta has expired. When the invalid timer Ta expires (when the period Ta elapses from turning on of the invalid flag for the touch bar 82 (disabling of the touch operation on the touch bar 82)), the process proceeds to S329, otherwise the process proceeds to S327.

In S329, the system control unit 50 resets the variable (number of consecutive steps) N to 0.

In S330, the system control unit 50 turns off all of invalid flags for the touch bar 82.

Touch Bar Operation Processing

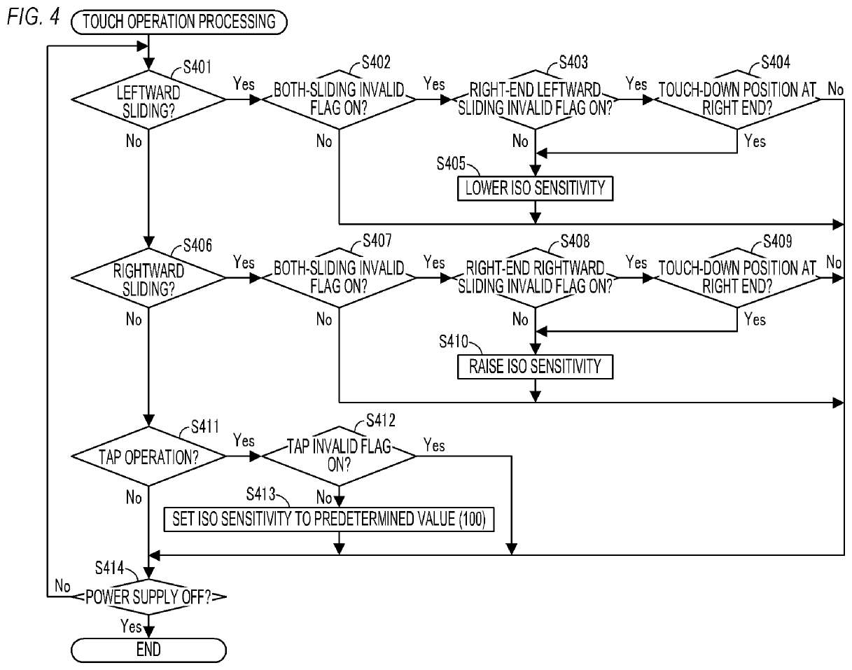

FIG. 4 is a flowchart for illustrating details of touch bar operation processing performed by the digital camera 100. The processing is implemented as the system control unit 50 deploys a program recorded in the non-volatile memory 56 in the system memory 52 and executes the program. For example, when the digital camera 100 is activated, the processing in FIG. 4 is started. The processing in FIG. 4 is performed in parallel with the processing in FIG. 3.

In S401, the system control unit 50 determines whether there has been leftward sliding to the touch bar 82. If there has been leftward sliding, the process proceeds to S402, otherwise the process proceeds to S406.

In S402, the system control unit 50 determines whether a both-sliding invalid flag is on. If the both-sliding invalid flag is on, the process proceeds to S414, otherwise the process proceeds to S403.

In S403, the system control unit 50 determines whether a right-end leftward sliding invalid flag is on. If the right-end leftward sliding invalid flag is on, the process proceeds to S404, otherwise the process proceeds to S405.

In S404, the system control unit 50 determines whether the start position (Touch-Down position) of the leftward sliding in S401 is at the right end of the touch bar 82. If the Touch-Down position is at the right end, the process proceeds to S405, otherwise the process proceeds S414.

In S405, the system control unit 50 reduces the ISO sensitivity by one level. In the description of the embodiment, the function of changing the ISO sensitivity is allocated to the operation on the touch bar 82 by way of illustration. However, the function allocated to the operation on the touch bar 82 is not particularly limited similarly to the function allocated to the operation on the sub-electronic dial 73.

In S406, the system control unit 50 determines whether there has been rightward sliding on the touch bar 82. If there has been rightward sliding, the process proceeds to S407, otherwise the process proceeds to S411.

In S407, the system control unit 50 determines whether the both-sliding invalid flag is on. If the both-sliding invalid flag is on, the process proceeds to S414, otherwise the process proceeds to S408.

In S408, the system control unit 50 determines whether the right-hand slide invalid flag is on. If the right-hand slide disable flag is on, the process proceeds to S409, otherwise the process proceeds to S410.

In S409, the system control unit 50 determines whether the start position (Touch-Down position) of the leftward sliding in S406 is at the right end of the touch bar 82. If the Touch-Down position is at the right end, the process proceeds to S410, otherwise the process proceeds to S414.

In S410, the system control unit 50 increases the ISO sensitivity by one level.

In S411, the system control unit 50 determines whether there has been tap operation on the touch bar 82. If there has been tap operation, the process proceeds to S412, otherwise the process proceeds to S414.

In S412, the system control unit 50 determines whether a tap invalid flag is on. If the tap invalid flag is on, the process proceeds to S414, otherwise the process proceeds to S413.

In S413, the system control unit 50 sets the ISO sensitivity to a predetermined value (for example, 100).

In S414, the system control unit 50 determines whether an instruction to turn off the power supply for the digital camera 100 has been given. If turning off of the power supply is instructed, the process ends the touch operation processing, otherwise the process proceeds to S401.

While the present invention has been described in detail with reference to a preferred embodiment thereof, these specific embodiments are not intended to limit the present invention, and various modes which do not depart from the gist and spirit of the present invention are also encompassed by the present invention. Furthermore, each of the embodiments described above is merely indicative of one embodiment of the present invention and the embodiments may be combined as appropriate.

The above-described various kinds of control performed by the system control unit 50 may be performed by one kind of hardware or the entire device may be controlled by a plurality of kinds of hardware (for example, a plurality of processors or circuits) which share the processing. In the above description of the embodiments, the present invention is applied to a digital camera (imaging device) as an example, but the present invention can be applied to any electronic device which can receive user operation. For example, the present invention can be applied to a personal computer, a PDA, a mobile phone terminal, a portable image viewer, a printer device, a digital photo frame, a music player, a game machine, an electronic book reader, and a video player. The present invention may also be applied to a display device (including a projector), a tablet terminal, a smartphone, an AI speaker, a home electrical appliance, a vehicle on-board device, and a medical device.

In addition to the imaging device main body, the present invention is also applicable to a control device which communicates with an imaging device (including a network camera) through wired or wireless communication and remotely controls the imaging device. Example of the device which remotely controls the imaging device include a smartphone, a tablet PC, and a desktop PC. The imaging device can be remotely controlled by notifying the imaging device of commands from the control device side to perform various kinds of operation and make settings on the basis of operation or processing performed on the control device side. In addition, live view images captured by the imaging device may be received through wired or wireless communication and displayed at the control device side.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the disclosure, erroneous operation attributable to incorrect touch operation by an operation body which performs operation on a particular operation member can be reduced.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-192660, filed on Oct. 23, 2019, which is hereby incorporated by reference herein in its entirety.

What is claimed is:

1. An electronic device comprising:
a particular operation member operable in a first direction by moving an operation body in the first direction;
a touch operation member provided further toward a side of the first direction than the particular operation member; and
at least one memory and at least one processor which function as a control unit configured to perform control to disable a first kind of operation on the touch operation member in response to that a first condition including performing of operation on the particular operation member in the first direction is satisfied.

2. The electronic device according to claim 1, wherein the touch operation member is provided to the side of the first direction from the particular operation member, with no other operation member being interposed therebetween.

3. The electronic device according to claim 1, wherein the touch operation member is an operation member provided toward the side of the first direction from the particular operation member and at a position closest to the particular operation member from among a plurality of operation members provided on an operation surface side on which the operation body performs operation on the particular operation member in the first direction.

4. The electronic device according to claim 1, wherein the touch operation member is provided at a distance, within two centimeters, from the particular operation member in the first direction.

5. The electronic device according to claim 1, wherein
the first kind of operation is sliding operation including touching the touch operation member to move a touch position in the first direction, and
even if the first condition is satisfied, the control unit does not disable touch operation different from the sliding operation on the touch operation member in the first direction.

6. The electronic device according to claim 5, wherein
the first kind of operation is the sliding operation started within a predetermined range from an end of an operation surface of the touch operation member in a second direction opposite to the first direction, and
even if the first condition is satisfied, the control unit does not disable sliding operation, started outside the predetermined range, on the touch operation member in the first direction.

7. The electronic device according to claim 1, wherein the first condition includes performing of at least a predetermined amount of operation on the particular operation member in the first direction.

8. The electronic device according to claim 1, wherein
the particular operation member is operable in a second direction opposite to the first direction by moving the operation body in the second direction, and
the control unit performs control to disable a second kind of operation on the touch operation member for a predetermined period in response to that a second condition including performing of operation on the particular operation member in the second direction is satisfied.

9. An electronic device comprising:
a particular operation member operable in a second direction by moving an operation body in the second direction;
a touch operation member provided further toward a side of a first direction opposite to the second direction than the particular operation member; and
at least one memory and at least one processor which function as a control unit configured to perform control to disable a second kind of operation on the touch operation member for a predetermined period in response to that a second condition including performing operation on the particular operation member in the second direction is satisfied.

10. The electronic device according to claim 9, wherein
the second kind of operation is sliding operation including touching the touch operation member to move a touch position in the second direction, and
even if the second condition is satisfied, the control unit does not disable touch operation different from the sliding operation on the touch operation member in the second direction.

11. The electronic device according to claim 10, wherein
the second kind of operation is the sliding operation started within a predetermined range from an end of an operation surface of the touch operation member in the second direction, and
even if the second condition is satisfied, the control unit does not disable sliding operation, started outside the predetermined rang, on the touch operation member in the second direction.

12. The electronic device according to claim 8, wherein the second condition includes performing of at least a predetermined amount of operation on the particular operation member in the second direction.

13. The electronic device according to claim 8, wherein the second condition includes consecutive performing of operation on the particular operation member in the second direction for at least a predetermined number of times.

14. The electronic device according to claim 1, wherein the particular operation member is a rotating dial which is rotatable in the first direction.

15. The electronic device according to claim 1, wherein the particular operation member is a slide switch which is slidable in the first direction.

16. The electronic device according to claim 1, further comprising a grip portion for holding the electronic device with one hand, wherein
the particular operation member and the touch operation member are each an operation member operable by a same finger of the hand that holds the grip portion.

17. The electronic device according to claim 16, wherein the same finger is a thumb of a right hand.

18. The electronic device according to claim 1, which is an imaging device having image sensor.

19. A control method of an electronic device including a particular operation member operable in a first direction by moving an operation body in the first direction, and a touch operation member provided further toward a side of the first direction than the particular operation member, the control method comprising:
receiving operation on the particular operation member; and
performing control to disable a first kind of operation on the touch operation member in response to that a first condition including performing of operation on the particular operation member in the first direction is satisfied.

20. A control method of an electronic device including a particular operation member operable in a second direction by moving an operation body in the second direction, and a touch operation member provided further toward a side of a first direction opposite to the second direction than the particular operation member, the control method comprising:
receiving operation on the particular operation member; and
performing control to disable a second kind of operation on the touch operation member for a predetermined period in response to that a second condition including performing operation on the particular operation member in the second direction is satisfied.

21. A non-transitory computer readable medium that stores a program, wherein
the program causes a computer to execute a control method of an electronic device including a particular operation member operable in a first direction by moving an operation body in the first direction, and a touch operation member provided further toward a side of the first direction than the particular operation member, and
the control method includes:
receiving operation on the particular operation member; and
performing control to disable a first kind of operation on the touch operation member in response to that a first condition including performing of operation on the particular operation member in the first direction is satisfied.

22. A non-transitory computer readable medium that stores a program, wherein
the program causes a computer to execute a control method of an electronic device including a particular operation member operable in a second direction by moving an operation body in the second direction, and a touch operation member provided further toward a side of a first direction opposite to the second direction than the particular operation member, and
the control method includes:
receiving operation on the particular operation member; and
performing control to disable a second kind of operation on the touch operation member for a predetermined period in response to that a second condition including performing operation on the particular operation member in the second direction is satisfied.
